(19) United States
(12) Patent Application Publication
(10) Pub. No.: US 2024/0211738 A1
(43) Pub. Date: Jun. 27, 2024

(54) APPARATUS AND METHOD WITH ENCRYPTED DATA NEURAL NETWORK OPERATION

(71) Applicants: SAMSUNG ELECTRONICS CO., LTD., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(72) Inventors: Jong-Seon NO, Seoul (KR); Junghyun LEE, Seoul (KR); Yongjune KIM, Daegu (KR); Joon-Woo LEE, Seoul (KR); Young Sik KIM, Gwangju (KR); Eunsang LEE, Seoul (KR)

(73) Assignees: SAMSUNG ELECTRONICS CO., LTD., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(21) Appl. No.: 18/488,497

(22) Filed: Oct. 17, 2023

(30) Foreign Application Priority Data
Dec. 23, 2022 (KR) 10-2022-0183695

(51) Int. Cl. G06N 3/048; G06N 3/08

(52) U.S. Cl. CPC G06N 3/048; G06N 3/08

(57) ABSTRACT

An apparatus and method with encrypted data neural network operation is provided. The apparatus includes one or more processors configured to execute instructions and one or more memories storing the instructions, wherein the execution of the instructions by the one or more processors configures the one or more processors to generate a target approximate polynomial, approximating a neural network operation, of a portion of a neural network model, using a determined target approximation region, for the target approximate polynomial, based on a first approximate polynomial generated based on parameters corresponding to a generation of the first approximate polynomial, a maximum value of input data to the portion of the neural network layer, and a minimum value of the input data, and generate a neural network operation result using the target approximate polynomial and the input data.

### CROSS-REFERENCE TO RELATED APPLICATIONS

This application claims the benefit under 35 USC § 119(a) of Korean Patent Application No. 10-2022-0183695, filed on Dec. 23, 2022, in the Korean Intellectual Property Office, the entire disclosure of which is incorporated herein by reference for all purposes.

### BACKGROUND

### 1. Field

The following description relates to an apparatus and method with encrypted data neural network operation.

### 2. Description of Related Art

Homomorphic encryption enables arbitrary operations between encrypted data without decrypting the encrypted data. Typical homomorphic encryption is lattice-based and thus resistant to quantum algorithms.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a computing apparatus includes one or more processors configured to execute instructions and one or more memories storing the instructions, wherein the execution of the instructions by the one or more processors configures the one or more processors to generate a target approximate polynomial, approximating a neural network operation, of a portion of a neural network model, using a determined target approximation region, for the target approximate polynomial, based on a first approximate polynomial generated based on parameters corresponding to a generation of the first approximate polynomial, a maximum value of input data to the portion of the neural network layer, and a minimum value of the input data, and generate a neural network operation result using the target approximate polynomial and the input data.

The execution of the instructions by the one or more processors may configure the one or more processors to generate the input data by implementing another portion of the neural network model.

The execution of the instructions by the one or more processors may configure the one or more processors to perform the generation of the target approximate polynomial and generation of the neural network operation result for each of plural portions of the neural network model, and generate a result of the neural network model dependent on each of the generated neural network operation results.

The one or more processors may be configured to set the approximation region based on the maximum value and the minimum value, and generate the target approximate polynomial by updating an approximate region of the first approximate polynomial based on the set approximation region.

The one or more processors are configured to set respective approximate regions of respective approximate polynomials, of plural rectified linear unit (ReLU) portions of the neural network model, based on a total number of the ReLU portions of the neural network model and a total number of input data samples input to the neural network model.

The neural network operation may include a rectified linear unit (ReLU), wherein the one or more processors are configured to calculate absolute values of data determined for input to the neural network operation, and calculate the maximum value based on the calculated absolute values.

The execution of the instructions by the one or more processors may configure the one or more processors to perform the generation of input data, the generation of the target approximate polynomial and generation of the neural network operation result for each of plural portions of the neural network model, and wherein a first approximation region generated corresponding to a first layer of the neural network model is different from a second approximation region generated corresponding to a second layer of the neural network model.

The parameters may include a precision parameter to control a precision of the target approximate polynomial with respect to the approximate region, and wherein, for the generation of the target approximate polynomials, the one or more processors are configured to calculate a precision threshold based on the precision parameter, and generate the first approximate polynomial such that an absolute value of an error between the neural network operation and the first approximate polynomial is equal to or less than the precision threshold.

For the determination of the target approximate region, the one or more processors may be configured to calculate an accuracy of an interim target approximate polynomial based on the first approximate polynomial, until a calculated accuracy of an updated interim target approximate polynomial meets an accuracy threshold: increment an update of an interim approximation region of the interim target approximate polynomial to generate the updated interim target approximate polynomial, and calculate the accuracy of the updated interim target approximate polynomial, wherein, when the updated interim target approximate polynomial meets the accuracy threshold, the updated interim target approximate polynomial is the generated target approximate polynomial.

In another general aspect, a processor-implemented method includes generating a target approximate polynomial, approximating a neural network of a portion of a neural network model, using a determined target approximation region, for the target approximate polynomial, based on a first approximate polynomial generated based on parameters corresponding to a generation of the first approximate polynomial, a maximum value of input data to the portion of the neural network layer, and a minimum value of input data, and generating a neural network operation result using the target approximate polynomial and the input data.

The method may include generating the input data by implementing another portion of the neural network model.

The generating of the target approximate polynomial and the generating of the neural network operation result may be performed for each of plural portions of the neural network model, and the method may further include generating a result of the neural network model dependent on each of the generated neural network operation results.

The generating of the target approximate polynomial may include setting the approximation region based on the maximum value and the minimum value, and generating the target approximate polynomial by updating an approximate region of the first approximate polynomial based on the set approximation region.

The setting of the approximation region may include setting respective approximate regions of respective approximate polynomials of plural rectified linear unit (ReLU) portions of the neural network model, based on a total number of the ReLU portions of the neural network model and a total number of input data samples input to the neural network model.

The generating of the target approximate polynomial may include calculating absolute values of data determined for input to the neural network operation, and calculating the maximum value based on the calculated absolute values.

The generation of input data, the generation of the target approximate polynomial and the generation of the neural network operation result may be performed for each of plural portions of the neural network model, and wherein a first approximation region generated corresponding to a first layer of the neural network model is different from a second approximation region generated corresponding to a second layer of the neural network model.

The generating of the target approximate polynomial may include calculating a precision threshold based on the precision parameter, and generating the first approximate polynomial such that an absolute value of an error between the neural network operation and the first approximate polynomial is equal to or less than the precision threshold.

The generating of the target approximate polynomial may include calculating an accuracy of an interim target approximate polynomial based on the first approximate polynomial.

Other features and aspects will be apparent from the following detailed description, the drawings, and the claims.

### BRIEF DESCRIPTION OF THE DRAWINGS

FIG. 1 illustrates an example computing apparatus according to one or more embodiments.

FIG. 2 illustrates an example method of generating an approximate polynomial according to one or more embodiments.

FIG. 3 illustrates an example method of calculating a maximum value and a minimum value of input data according to one or more embodiments.

FIG. 4 illustrates an example method of generating an approximate polynomial according to one or more embodiments.

FIG. 5 illustrates an example method of calculating an approximation region according to one or more embodiments.

FIG. 6 illustrates an example graph demonstrating an error for an input outside an approximation region according to one or more embodiments.

FIG. 7 illustrates an example method according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

A machine learning model (e.g., a neural network model) may be utilized for homomorphic encrypted data. For example, it is found that a polynomial with a low degree may be used, e.g., as an activation function, to perform a neural network operation using the homomorphic encrypted data. However, layers of the typical neural network model may not be deeply stacked when the one polynomial of the low degree is utilized, and thus it becomes difficult to achieve high performance.

On the other hand, it is found that a polynomial with a high degree is typically required as the activation function to accurately approximate a rectified linear unit (ReLU) of the neural network operation to a polynomial. Thus, in this case, multiple times of bootstrapping have typically been required to implement the polynomial as the activation function in a deep neural network, which requires an excessive amount of time to implement.

Additionally, it is found that, in such neural network operation for the fully homomorphic encrypted data using the high degree polynomial, the typical neural network model needs to be retrained based on the high degree polynomial having replaced the existing activation function of the typical neural network model, e.g., having replaced a standard ReLU activation function in the typical neural network model, which also requires significantly more resources than the standard ReLU function or other replaced activation function. These typical operations not only have certain limitations to achieve high performance, but are also very time consuming and require significant resources.

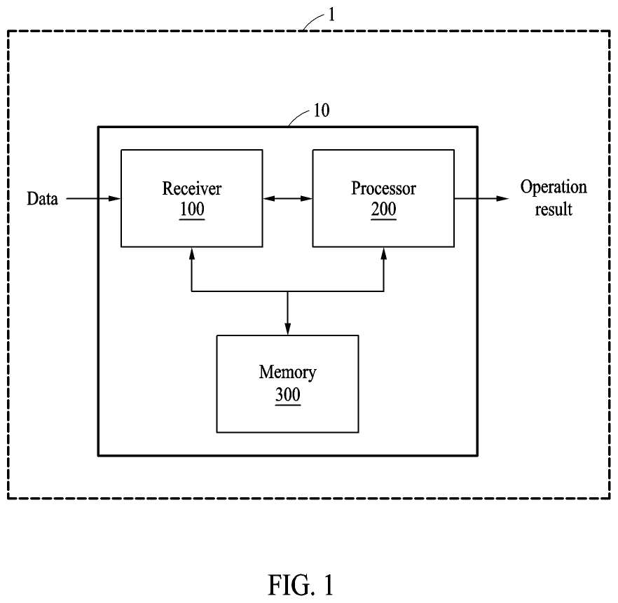

FIG. 1 illustrates an example computing apparatus according to one or more embodiments.

Referring to FIG. 1, an example computing apparatus 10 may be configured to perform a neural network operation of a neural network model. In an example, the computing apparatus 10 may perform training and/or inference operations of a machine leaning model for homomorphic encrypted data. The computing apparatus 10 may also be a component or operation of an electronic device 1, or the computing apparatus may be the electronic device.

In an example, the computing apparatus 10 may be configured to perform a neural network operation in a neural network that is provided (e.g., acts on) homomorphic encrypted data. Homomorphic encryption may refer to a method of encryption configured to allow various operations to be performed on data that is still encrypted. In homomorphic encryption, a result of an operation using ciphertexts may become a new ciphertext, and a plaintext obtained by decrypting the ciphertext may be the same as an operation result of the original data before the encryption.

A neural network model is a type of machine learning model having a problem-solving or other inference capability implemented through nodes of respective layers of the neural network model with connections therebetween.

The neural network model may include one or more layers, each including one or more nodes. The neural network model may be trained to infer a result from an input by incrementally adjusting weights of the nodes through training. The nodes of each of the layers of the neural network model may respectively include weights corresponding to the respectively connected outputs of a previous layer to respective nodes of a current layer. Each of such nodes of the plural layers may also include respective biases that may be determined or set during training, for example. The connections between the nodes may also be considered to be weighted connections, in which case such weights may be applied to respective outputs of a previous layer, for example, some or all of which may be referred to as respective output activations. In such an example, one or more respective weighted activations may be understood to be input to each node of a current layer.

As non-limiting example, the neural network model may include a deep neural network (DNN). The neural network model may include any one of a convolutional neural network (CNN), a recurrent neural network (RNN), a perceptron, a multilayer perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and/or an attention network (AN), or other machine learning models may be used, as non-limiting examples.

The computing apparatus 10 may be a personal computer (PC), a data server, or a portable device, or the electronic device 1 may be the PC, the data server, or the portable device.

The portable device may be, as non-limiting examples, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be a smart watch, a smart band, a smart ring, or the like.

The computing apparatus 10 may perform a neural network operation using an accelerator. The computing apparatus 10 may be implemented inside or outside the accelerator, or may be the accelerator.

As non-limiting examples, the accelerator may include a neural processing unit (NPU), a graphics processing unit (GPU), a field-programmable gate array (FPGA), an application-specific integrated circuit (ASIC), or an application processor (AP). Alternatively, the accelerator may be implemented as one or more processors that execute computer-readable instructions that configure the one or more processors to perform any one or any combination of the operations and/or methods described herein within a software computing environment, such as a virtual machine or the like.

In an example of FIG. 1, the computing apparatus 10 may include a receiver 100, a processor 200, and memory 300. The receiver 100, processor 200, and memory 300 are each also representative of respectively different or same receiver, processor, and memory of the electronic device 1.

The receiver 100 may include a receiving interface, through which various data are received by the receiver 100. The receiver 100 may receive data from an external device or the memory 300, or another processor also represented by the processor 200. The receiver 100 may output the received data to the processor 200. In an example, the receiver may not be included. Such data and parameters may also be obtained or generated by the processor 200, in which case the processor 200 may also be configured to perform the functions of the receiver.

The receiver 100 may receive data for performing a predetermined computing task that includes a machine learning model, e.g., a neural network, and parameters for generating a target approximate polynomial corresponding to the neural network operation of the task.

The data for performing the neural network operation may include respective input data input to a neural network model, or layers or neural network operation portions of the layers of the neural network model. The parameters for generating the target approximate polynomial may include a precision parameter setting a select precision (e.g., to strive toward ensuring precision) of the target approximate polynomial. The neural network operation may include respective non-linear or other activation functions of nodes of one or more layers. For example, the network operation may include a rectified linear unit (ReLU) function.

The processor 200 may process data stored in the memory 300. The processor 200 may execute a computer-readable instructions (e.g., code or software) stored in the memory 300. The execution of the instructions by the processor 200 may configure the processor 200 to perform any one or any combinations of the operations/methods described herein.

The processor 200 may include one or more data processing devices embodied by hardware having a circuit of a physical structure to execute desired operations. The desired operations may include, for example, such instructions that may be included in a program, as a non-limiting example, which may be stored in the memory 300. The execution of the instructions by the one or more data processing devices may configure the processor 200 to perform any one or any combinations of the operations/methods described herein.

The one or more hardware-implemented data processing devices may each be, for example, one of a microprocessor, a central processing unit (CPU), a processor core, a multi-core processor, a multiprocessor, an application-specific integrated circuit (ASIC), and a field-programmable gate array (FPGA), as non-limiting examples.

The processor 200 may calculate a maximum value and a minimum value of respective input data to one or more layers (e.g., ReLU layers), or a neural network operation portion of such layers, of a neural network model based on data input to the neural network.

The processor 200 may generate a target approximate polynomial by determining an approximation region based on a first approximate polynomial generated based on the parameters, the maximum value, and the minimum value.

The processor 200 may calculate a precision based on the precision parameter. The processor 200 may generate the first approximate polynomial such that an absolute value of an error between a reference neural network operation (e.g., a typical/standard ReLU operation) and the first approximate polynomial is equal to or less than (e.g., meeting) the precision.

The processor 200 may set the approximation region for respective approximate polynomials for each of the ReLU layers of the neural network based on the respective maximum value and the respective minimum value for each input to each ReLU layer. In one example, the processor 200 may set the approximation region for respective ReLU layers based on the number of ReLU layers included in the neural network model and the total number of respective input data to the neural network model.

The processor 200 may calculate respective absolute values of pieces of respective input data of the ReLU layers of the neural network model. In an example, the processor 200 may generate each approximation region of each ReLU layer based on respective maximum values of the respective absolute values.

A first approximation region generated corresponding to a first layer (e.g., a first ReLU layer) of the neural network model may be different from a second approximation region generated corresponding to a second layer (e.g., a second ReLU layer) of the neural network model.

For the first example ReLU layer, the processor 200 may generate the target approximate polynomial by updating/transforming the first approximate polynomial with respect to the approximation region. The processor 200 may calculate an accuracy value of the updated approximate polynomial, and incrementally again update the approximation region until a calculated accuracy value of the updated approximate polynomial meets or is equal to or greater than a predetermined accuracy value or threshold.

The processor 200 may be configured to implement the neural network using the target approximate polynomial instead of an original neural network operation of the neural network. For example, the neural network may have a ReLU layer that uses a typical ReLU unit or function for an insertion of non-linearity, but the typical ReLU of the neural network may be replaced (updated) with the target approximate polynomial, and act on input data from another layer of the neural network when the neural network is input homomorphic encrypted data.

The memory 300 may store computer-readable instructions executable by the processor 200. For example, the instructions include instructions for performing any one or any combinations of the operations of the processor 200 and/or each component of the processor 200.

The memory 300 may be embodied by a volatile or non-volatile memory device.

As non-limiting examples, the volatile memory device may be a dynamic random access memory (DRAM), a static random access memory (SRAM), a thyristor RAM (T-RAM), a zero capacitor RAM (Z-RAM), or a twin transistor RAM (TTRAM).

As non-limiting examples, the non-volatile memory device may be an electrically erasable programmable read-only memory (EEPROM), a flash memory, a magnetic RAM (MRAM), a spin-transfer torque-MRAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano-floating gate memory (NFGM), a holographic memory, a molecular electronic memory device, or an insulator resistance change memory.

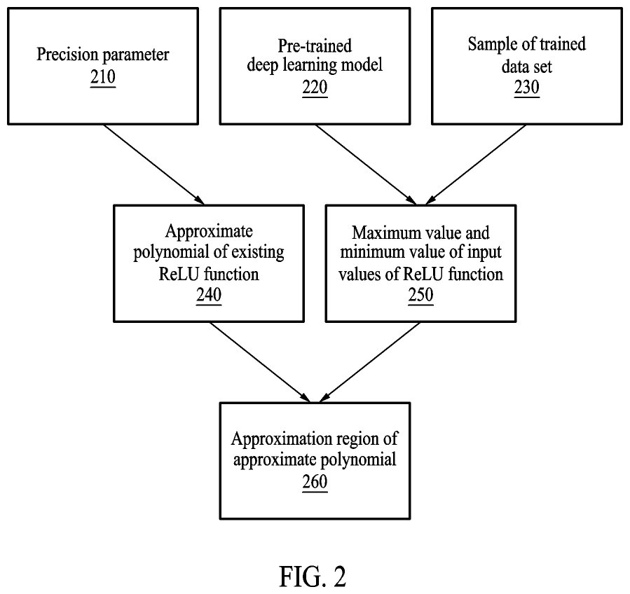

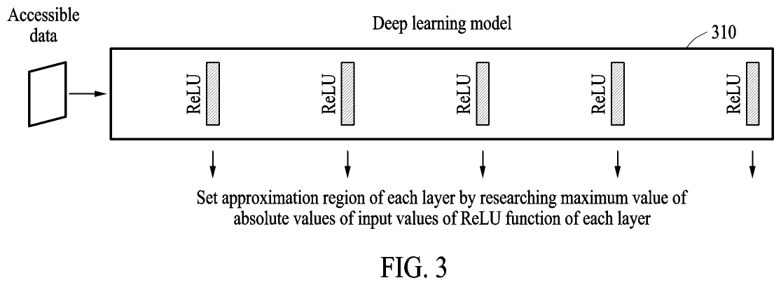

FIG. 2 illustrates an example operation generating an approximate polynomial by a computing apparatus (e.g., the computing apparatus of FIG. 1), and FIG. 3 illustrates an example operation of calculating a maximum value and a minimum value of input data, according to one or more embodiments.

Referring to FIGS. 2 and 3, when approximating a rectified linear unit (ReLU unit) (or a ReLU function) used in typical neural networks for fully homomorphic encrypted data, a processor (e.g., the processor 200 of FIG. 1) may effectively generate a target approximate polynomial that approximates the ReLU unit/function of a ReLU layer by adjusting respective approximation regions of a polynomial for the ReLU layer (and/or ReLU portions of the layers) of the neural network 310.

The processor 200 may obtain maximum and minimum values of respective input values to the ReLU functions of the example ReLU layers of the neural network 220 to be approximated.

The ReLU functions may be functions of respective ReLU layers, which may each follow another layer of the neural network 220 that may perform a different neural network operation (e.g., a convolution layer, a pooling layer, or normalization layer), as non-limiting examples and/or may be activation functions of respective other neural network function layers (e.g., fully connected or feed forward layer, a layer of a multilayer perception, the convolution layer, or any other layer, such as where stochastic gradient descent backpropagation training is desired) when the ReLU function is an activation function of the respective nodes of the other neural network function layer, as non-limiting examples. Thus, while below examples will be discussed with respect to ReLU layers, the same is also applicable where the ReLU functions are included in nodes of a layer that also performs the other neural network operation.

The processor 200 may adjust the approximation region using the obtained minimum and maximum values. Through this operation, the processor 200 may effectively set a target approximation region for an interim approximate polynomial with the same degree (e.g., without having to change a degree of the interim approximate polynomial), thereby increasing the accuracy of approximation.

The processor 200 may generate the neural network 310 for the fully homomorphic encrypted data with high accuracy (e.g., a predetermined accuracy threshold of the target approximate polynomial for the neural network operation of homomorphic encrypted data) while using a low polynomial degree, by effectively setting the approximation region of the approximate polynomial based on the values of the input data. For example, the generated neural network 310 may correspond to the trained neural network 220 except that the ReLU layers now apply the respective target approximate polynomials instead of the ReLU units/functions of the ReLU layers in the trained neural network 220.

The processor 200 may effectively set the approximation region in consideration of the range of the input data when approximating the ReLU ReLu(x)=max{x,0} for the fully homomorphic encrypted data.

The processor 200 may receive a precision parameter 210, a pre-trained machine learning model (e.g., a deep learning model or other neural network) 220, and a sample 230 of a trained data set. The processor 200 may generate a first approximate polynomial (e.g., an approximate polynomial 240 that approximates an existing ReLU unit/function of the neural network model 220) based on the precision parameter.

The processor 200 may use an approximate polynomial r_{α}(x) that minimizes depth consumption as the first approximate polynomial while ensuring a precision of 2^{-α} or less, for example, in a section [−1,1] when precision parameter α is given.

The processor 200 may calculate a precision based on the precision parameter. The processor 200 may generate the first approximate polynomial such that an absolute value of an error between the neural network operation (e.g., the standard/typical ReLU unit/function) and the first approximate polynomial is equal to or less than the precision. For example, the training data set may be input to the trained neural network 220 and outputs of the ReLU function units can be compared to the case when the ReLU functions/units are replaced by an in-training approximate polynomial that is updated (e.g., by changing the approximation region) until the precision parameter (or threshold based on the same) is met, where the first approximate polynomial may be the interim approximate polynomial that meets the precision threshold. For example, the first approximate polynomial r_{α}(x) may be a polynomial in which |r_{α}(x)−ReLU(x)|≤2^{-α} is satisfied in the section [−1,1].

The processor 200 may calculate maximum and minimum values 250 of the input values of the ReLU function based on the pre-trained deep learning model 220 and the sample 230 of the trained data set. The sizes of the precision parameter and the sample of the data set may be determined by a user of a computing apparatus (e.g., the computing apparatus 10 of FIG. 1), as a non-limiting example.

The processor 200 may calculate an approximation region 260 of a target approximate polynomial based on the first approximate polynomial (e.g., the approximate polynomial 240 that approximate the existing ReLU function) and the maximum and minimum values 250 of the input values of the ReLU function. The processor 200 may generate the target approximate polynomial by updating/transforming the first approximate polynomial based on changes to the approximation region.

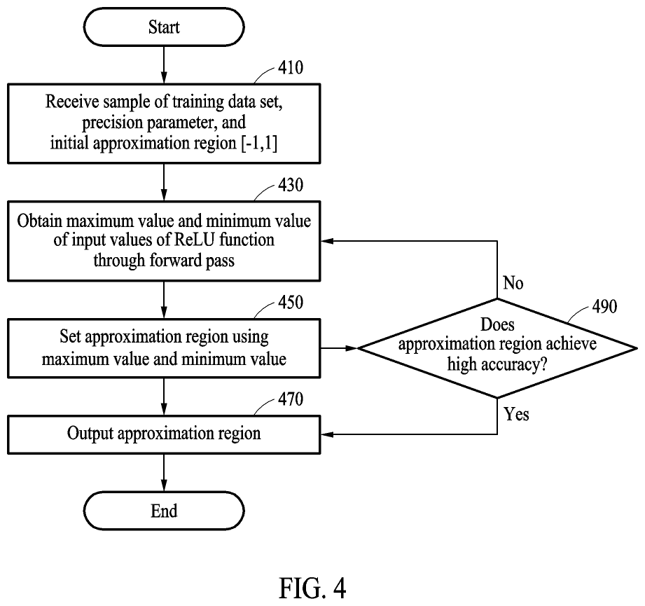

FIG. 4 illustrates an example method of generating an approximate polynomial according to one or more embodiments.

Referring to FIG. 4, in operation 410, a processor (e.g., the processor 200 of FIG. 1) may receive a sample of a training data set, a precision parameter, and an initial approximation region (e.g., [−1,1]). As a non-limiting example, the sample of the training data set and the precision parameter may be determined by a user of a computing apparatus (e.g., the computing apparatus 10 of FIG. 1), as a non-limiting example.

During a forward pass of the neural network, the processor 200 may calculate maximum and minimum values of pieces of input data to a ReLU function/unit that is to be approximated.

In operation 450, the processor 200 may set a new approximation region using the calculated maximum and minimum values.

In operation 490, the processor 200 may determine whether the set approximation region achieves a high accuracy (e.g., the predetermined accuracy of the target approximate polynomial for the neural network operation).

In operation 470, if the high accuracy threshold is not achieved through the set approximation region, the processor 200 may repeat the operation of newly setting the approximation region using the maximum and minimum values in the obtained approximation region. When the predetermined accuracy threshold is achieved, the processor 200 may generate/output the set approximation region for use with the approximate polynomial that replaces a ReLU unit/function of a ReLU layer of the neural network.

When the processor 200 applies the approximate polynomial described above in the ReLU layer (instead of the existing ReLU units/functions) of a deep learning model, the performance may vary depending on the training degree of the trained neural network 220.

In general, the narrower the approximation region, the lower the approximation error, resulting in high performance. However, if the approximation region is excessively narrow, input data outside the approximation region may be generated. When the input data outside the approximation region is generated, a considerable error may occur in an output value (e.g., a result of the neural network operation), which may cause an overflow.

The processor 200 may adjust the approximation region to prevent the overflow. For example, when the input data outside the approximation region is generated, the processor 200 may change or adjust the approximation region to be wider than the obtained approximation region. For example, when an approximation region [−Bᵢ,Bᵢ] is determined not suitable, the processor 200 may use an alternate approximation region [−1.05Bᵢ,1.05Bᵢ] that is wider by a non-limiting example 5%. The processor 200 may search for an approximation region meeting the high accuracy threshold, while expanding the approximation region, for each ReLU layer of the neural network that also include respective approximate polynomials.

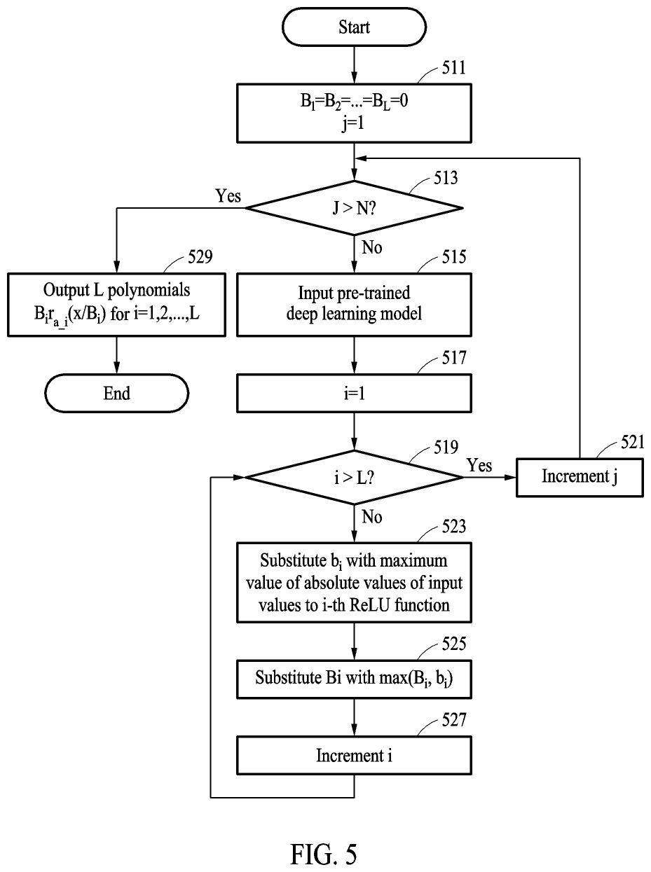

FIG. 5 illustrates an example method of calculating an approximation region according to one or more embodiments.

Referring to FIG. 5, a processor (e.g., the processor 200 of FIG. 1) may generate a respective target approximate polynomial for each neural network operation layer (e.g., each ReLU layer) by setting respective approximation regions optimized for each neural network operation layer by using a pre-trained neural network (e.g., the pre-trained deep learning model 220), input data generated in the neural network, and precision parameters (e.g., the precision parameter 210).

In an example of FIG. 5, L represents the number of ReLU layers in a neural network to be respectively approximated and N represents the total number of pieces/samples of input data to the neural network. The processor 200 may set the approximation region based on the number of ReLU layers included in the neural network and the total number of pieces/samples of input data to the neural network.

The processor 200 may perform the process described with reference to FIG. 5 for the pieces/samples of input data by using the indexed pieces/samples x₁, x₂, . . . , x_{N} to be input to pre-trained neural network (e.g., the pre-trained deep learning model 220).

In operation 511, the processor 200 may be configured to set a respective initial value of an approximation region corresponding to each of the ReLU layers of the pretrained neural network.

In operation 513, the processor 200 may determine whether j is greater than N. Here, j denotes an index of the pieces/samples plural input data.

In operation 515, when j is not greater than N (i.e., there are remaining pieces/samples data to consider), the processor 200 may input x_{j.} to the pre-trained neural network.

In operation 517, the processor 200 may be configured to set i to 1.

In operation 519, the processor 200 may be configured to determine whether i is greater than L (i.e., whether an approximate polynomial with an approximate range has been generated for each ReLU layer of the trained neural network based on the current x_{j.} piece/sample data.

In operation 523, when i is not greater than L, the processor 200 may substitute an existing accumulation range maximum value bᵢ of an i-th ReLU layer, with a maximum value of absolute values of the corresponding input data to the i-th ReLU. In an example, the respective inputs to (and respective outputs from) each of the L ReLU layers may be predetermined for each of the N pieces/samples of input data to the trained neural network.

In operation 525, the processor 200 may be configured to substitute Bᵢ with max(Bᵢ, bᵢ). Though repetition of operations 523 and 525, as the processor 200 increments i in operation 527, the processor 200 may extend the process of setting the approximation regions based on to all N pieces/samples. That is, the processor 200 may examine all data input to the i-th (through L-th ReLU layer) ReLU layer for each input data xⱼ, through X_{N}.

With respect to each performance of operation 527, when a maximum value of absolute values of an input data to an i-th ReLU layer is defined as bᵢⱼ, the processor 200 may obtain the approximation region for the i-th ReLU layer using

$${B}_{i} = {max}_{j} {b}_{ij} .$$

In operation 521, when i is greater than L in operation 519, the processor 200 may be configured to increment j with j+1.

In operation 529, when j is greater than N (i.e., all pieces/samples input data has been considered) in operation 513, the processor 200 may output the current/final L approximate polynomials.

According to the above description, the processor 200 may obtain an approximation region [−Bᵢ,Bᵢ] of the target approximate polynomial. The processor 200 may generate the target approximate polynomial of the ReLU, in which the approximation region is [−Bᵢ,Bᵢ], as Expression 1.

$${B}_{i} {r}_{{α}_{i}} ( \frac{x}{{B}_{i}} ) \qquad Expression 1$$

Here, αᵢ represents a precision parameter corresponding to the i-th ReLU of the neural network (e.g., the trained learning model 220). [−Bᵢ,Bᵢ] represents the approximation region of the i-th ReLU. The process of generating a first approximate polynomial using the precision parameter may be the same as that described above with reference to FIGS. 2 and 3.

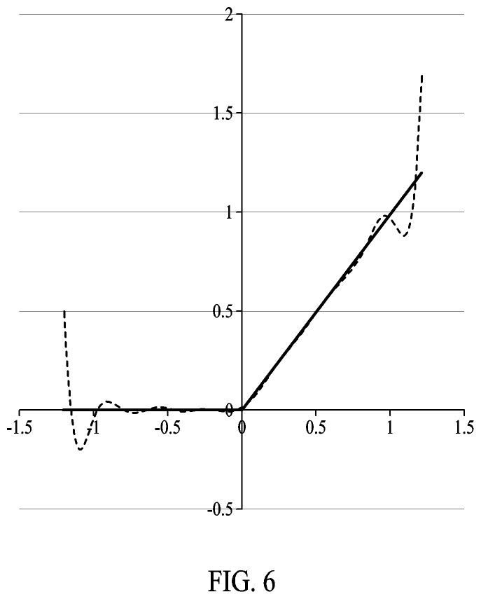

FIG. 6 illustrates an example graph demonstrating an error for an input to a ReLU layer outside an approximation region according to one or more embodiments.

Referring to FIG. 6, in an example, when input data outside an approximation region is received by this ReLU layer with the polynomial approximated ReLU units/functions, a relatively large error may occur, compared to the typical ReLU.

A solid line represents an accurate typical ReLU and a dotted line represents an approximate polynomial approximated in an approximation region [−1,1].

A processor (e.g., the processor 200 of FIG. 1) may be configured to adjust/update the approximation region to prevent an overflow from occurring due to the input data outside the approximation region. The process of adjusting/updating the approximation region may be the same as that described above with reference to FIG. 4.

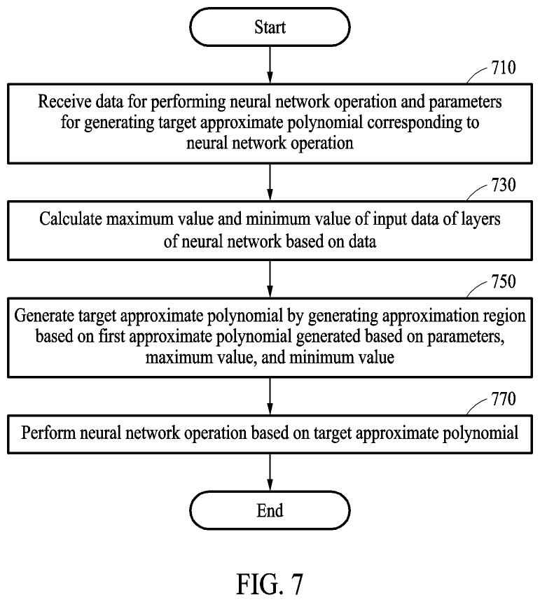

FIG. 7 illustrates an example method according to one or more embodiments.

Referring to FIG. 7, in operation 710, a receiver (e.g., the receiver 100 of FIG. 1) may receive data for performing a neural network operation and respective parameters for generating the respective target approximate polynomials corresponding to the neural network operation (e.g., for each of ReLU layers of a neural network).

In operation 730, as information is generated and processed through (with) the forward pass of the neural network, when each ReLU layer is reached, the processor 200 may be configured to respectively calculate a maximum value and a minimum value of the corresponding input data generated up to that point of the corresponding ReLU layer (i.e., the data/information within the neural network that otherwise would have been input to a corresponding typical ReLU activation function) of a neural network (e.g., the trained learning model 220) based on the data as a non-limiting example.

In operation 750, for each ReLU layer being replaced by a corresponding polynomial (e.g., operations 730 and 750 and respective input data and corresponding parameters may be performed for each ReLU as the forward pass proceeds to each ReLU layer), the processor 200 may generate a target approximate polynomial by generating an approximation region based on a corresponding approximate polynomial, of a corresponding ReLU layer, generated based on the parameters, the corresponding maximum value, and the corresponding minimum value.

Using a first approximate polynomial of a first ReLU layer, the processor 200 may calculate a precision based on a received precision parameter. The processor 200 may generate the first approximate polynomial such that an absolute value of an error between the neural network operation (i.e., the typical ReLU) and the first approximate polynomial is equal to or less than the precision.

The processor 200 may set the approximation region based on the corresponding maximum value and the corresponding minimum value. The processor 200 may set respective approximation regions based on the number of ReLU layers included in the neural network and the corresponding number of pieces/samples of data input to the neural network.

In an example, the processor 200 may calculate absolute values of the generated or stored pieces of respective input data of each ReLU layer of the neural network model, and calculate a corresponding maximum value among the absolute values. The processor 200 may generate the approximation region based on a maximum value of the absolute values of an input to a corresponding ReLU layer.

A first approximation region generated corresponding to the first ReLU layer of the neural network may be different from a second approximation region generated corresponding to a second ReLU layer of the neural network, as the input data to the first ReLU layer is typically different from the input data to the second ReLU layer, as other (non-ReLU) neural network portions/layer(s) may act on the results of the first ReLU layer before the result of these other layer(s) is the input data to the second ReLU layer of the neural network.

With respect to the first ReLU layer, the processor 200 may generate a corresponding target approximate polynomial by transforming the first approximate polynomial based on the approximation region. For example, the processor 200 may calculate an accuracy of the target approximate polynomial. The processor 200 may be configured to incrementally update the approximation region of the first approximate polynomial (of the first ReLU layer) until the accuracy reaches the high accuracy threshold (e.g., a predetermined accuracy threshold of this target approximate polynomial).

In operation 770, the processor 200 may configured to generate a homomorphic encrypted data operation result by inputting the homomorphic encrypted data to a resultant neural network and performing each of the layers of the neural network, including the one or more ReLU layers that respectively apply their target approximate polynomials instead of a typical ReLU operation.

The processors, memories, electronic devices, apparatuses, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An computing apparatus, comprising:
one or more processors configured to execute instructions; and
one or more memories storing the instructions,
wherein the execution of the instructions by the one or more processors configures the one or more processors to:
generate a target approximate polynomial, approximating a neural network operation of a portion of a neural network model, using a determined target approximation region for the target approximate polynomial based on a first approximate polynomial generated based on parameters corresponding to a generation of the first approximate polynomial, a maximum value of input data to the portion of the neural network layer, and a minimum value of the input data; and
generate a neural network operation result using the target approximate polynomial and the input data.

2. The computing apparatus of claim 1, wherein the execution of the instructions by the one or more processors configures the one or more processors to:
generate the input data by implementing another portion of the neural network model.

3. The computing apparatus of claim 2, wherein the execution of the instructions by the one or more processors configures the one or more processors to:
perform the generation of the target approximate polynomial and generation of the neural network operation result for each of plural portions of the neural network model; and
generate a result of the neural network model dependent on each of the generated neural network operation results.

4. The computing apparatus of claim 1, wherein the one or more processors are configured to:
set the approximation region based on the maximum value and the minimum value; and
generate the target approximate polynomial by updating an approximate region of the first approximate polynomial based on the set approximation region.

5. The computing apparatus of claim 4, wherein the one or more processors are configured to:
set respective approximate regions of respective approximate polynomials, of plural rectified linear unit (ReLU) portions of the neural network model, based on a total number of the ReLU portions of the neural network model and a total number of input data samples input to the neural network model.

6. The computing apparatus of claim 1,
wherein the neural network operation comprises a rectified linear unit (ReLU), and
wherein the one or more processors are configured to:
calculate absolute values of data determined for input to the neural network operation; and
calculate the maximum value based on the calculated absolute values.

7. The computing apparatus of claim 1, wherein the execution of the instructions by the one or more processors configures the one or more processors to:
perform the generation of the target approximate polynomial and generation of the neural network operation result for each of plural portions of the neural network model; and
wherein a first approximation region generated corresponding to a first layer of the plural portions is different from a second approximation region generated corresponding to a second layer of the plural portions.

8. The computing apparatus of claim 1,
wherein the parameters comprise a precision parameter to control a precision of the target approximate polynomial with respect to the approximate region, and
wherein, for the generation of the target approximate polynomials, the one or more processors are configured to:
calculate a precision threshold based on the precision parameter; and
generate the first approximate polynomial such that an absolute value of an error between the neural network operation and the first approximate polynomial is equal to or less than the precision threshold.

9. The computing apparatus of claim 1, wherein, for the determination of the target approximate region, the one or more processors are configured to:
calculate an accuracy of an interim target approximate polynomial based on the first approximate polynomial;
until a calculated accuracy of an updated interim target approximate polynomial meets an accuracy threshold:
increment an update of an interim approximation region of the interim target approximate polynomial to generate the updated interim target approximate polynomial; and
calculate the accuracy of the updated interim target approximate polynomial, wherein, when the updated interim target approximate polynomial meets the accuracy threshold, the updated interim target approximate polynomial is the generated target approximate polynomial.

10. A processor-implemented method, comprising:
generating a target approximate polynomial, approximating a neural network operation of a portion of a neural network model, using a determined target approximation region for the target approximate polynomial based on a first approximate polynomial generated based on parameters corresponding to a generation of the first approximate polynomial, a maximum value of input data to the portion of the neural network layer, and a minimum value of input data; and
generating a neural network operation result using the target approximate polynomial and the input data.

11. The method of claim 10, further comprising generating the input data by implementing another portion of the neural network model.

12. The method of claim 11, further comprising:
performing the generating of the target approximate polynomial and the generating of the neural network operation result for each of plural portions of the neural network model; and
generating a result of the neural network model dependent on each of the generated neural network operation results.

13. The method of claim 10, wherein the generating of the target approximate polynomial comprises:
setting the approximation region based on the maximum value and the minimum value; and
generating the target approximate polynomial by updating an approximate region of the first approximate polynomial based on the set approximation region.

14. The method of claim 13, wherein the setting of the approximation region comprises:
setting respective approximate regions of respective approximate polynomials of plural rectified linear unit (ReLU) portions of the neural network model, based on a total number of the ReLU portions of the neural network model and a total number of input data samples input to the neural network model.

15. The method of claim 10, wherein the generating of the target approximate polynomial comprises:
calculating absolute values of data determined for input to the neural network operation; and
calculating the maximum value based on the calculated absolute values.

16. The method of claim 10,
wherein the generation of the target approximate polynomial and the generation of the neural network operation result are performed for each of plural portions of the neural network model, and
wherein a first approximation region generated corresponding to a first layer of the plural portions is different from a second approximation region generated corresponding to a second layer of the plural portions.

17. The method of claim 10, wherein the generating of the target approximate polynomial comprises:
calculating a precision threshold based on the precision parameter; and
generating the first approximate polynomial such that an absolute value of an error between the neural network operation and the first approximate polynomial is equal to or less than the precision threshold.

18. The method of claim 10, wherein the generating of the target approximate polynomial comprises:
calculating an accuracy of an interim target approximate polynomial based on the first approximate polynomial; and
until a calculated accuracy of an updated interim target approximate polynomial meets an accuracy threshold:
incrementing an update of an interim approximation region of the interim target approximate polynomial to generate the updated interim target approximate polynomial; and
calculating the accuracy of the updated interim target approximate polynomial,
wherein, when the updated interim target approximate polynomial meets the accuracy threshold, the updated interim target approximate polynomial is the generated target approximate polynomial.

19. The method of claim 12, wherein the neural network operation is a ReLU function.

20. A non-transitory computer-readable storage medium storing instructions that, when executed by a processor, cause the processor to perform the method of claim 10.
